(19) United States
(12) Patent Application Publication
(10) Pub. No.: US 2013/0001218 A1
(43) Pub. Date: Jan. 3, 2013

(54) MOLDED BODY, HEATING DEVICE AND METHOD FOR PRODUCING A MOLDED BODY

(75) Inventors: Jan Ihle, Grambach (AT); Bernhard Steinberger, Seiersberg (AT)

(73) Assignee: EPCOS AG, Munich (DE)

(21) Appl. No.: 13/520,169

(22) PCT Filed: Dec. 9, 2010
(86) PCT No.: PCT/EP2010/069301

§ 371 Date: Sep. 13, 2012

(30) Foreign Application Priority Data
Jan. 5, 2010 (DE) 102010004051.7

(51) Int. Cl. H05B 3/14; B32B 18/00; B32B 7/02; C04B 35/64

(52) U.S. Cl. 219/541; 264/642; 219/553; 428/212

(57) ABSTRACT

A molded body is provided, having a first region (10) comprising a first ceramic material with a positive temperature coefficient of the electric resistance and a second region (20) comprising a second material and a third region (30) comprising a third ceramic material. Furthermore, the invention relates to a heating device comprising said molded body. Furthermore, a method for producing a molded body is provided.

Molded body, heating device and method for producing a molded body

The invention relates to a molded body, a heating device which comprises the molded body and a method for producing a molded body.

Media, for example fluids, can be heated by means of thermal contact with materials that have a positive temperature coefficient of the electrical, resistance (PTC materials). Such PTC materials can so far be shaped as sheets or rectangular elements that consist of a PTC material. In contact with aggressive media, such as for example acids or bases, and under high mechanical loading, such PTC materials often only have a short service life.

A problem to be solved is that of providing a molded body that has a high mechanical strength and chemical stability and comprises a material with PTC properties. This problem is solved by a molded body according to patent claim 1. Further embodiments of the molded body, a heating device comprising a molded body and a method for producing a molded body are the subject of further patent claims.

According to one embodiment, a molded body which comprises a first region, a second region and a third region which is arranged between the first region and the second region is provided. The first region has a first ceramic material with a positive temperature coefficient of the electrical resistance and the second region has a second ceramic material. The third region has a third ceramic material. In this case, the first region and the third region have coefficients of thermal expansion which differ by less than 2*10⁻⁶/K, and the second region and the third region have coefficients of thermal expansion which differ by less than 2*10⁻⁶/K. All three regions can have different coefficients of expansion in this case.

The first ceramic material comprises an electroactive ceramic, which constitutes the functional component in the molded body. The second ceramic material comprises a structural ceramic, which constitutes the shaping component in the molded body. Therefore, the first region comprises an electroactive region and the second region comprises a structural ceramic region.

The third ceramic material comprises a thermally adapted ceramic material, which constitutes the intermediary component between the electroactive ceramic and the structural ceramic. Therefore, the third region is an intermediary or transition region.

This provides a one-piece molded body in which there is a material composite of a first and second ceramic material which are connected to one another via a third ceramic material. Therefore, shaping components in the form of the structural ceramic material and functional components in the form of the electroceramic material are combined in one molded body and connected to one another via a thermally adapted ceramic material.

Hereinbelow, “coefficient of expansion” always refers to a coefficient of thermal expansion, even if this is not expressly mentioned. By way of example, the coefficient of expansion may be a coeffcient of linear expansion.

Furthermore, the third region of the molded body can have at least two partial regions, in which case the first region and the second region adjoin in each case one of the partial regions. Therefore, the first region adjoins a different partial region of the third region than the second region. The partial regions can be shaped in layer form, such that at least two layers of the third region are located between the first region and the second region.

The thickness of a partial region, which is shaped as a layer, can be between 5 μm and 100 μm, for example, depending on the design standards which the molded body has no meet. The thickness of a partial region should be at least three times the mean grain size of the ceramic starting material from which the third ceramic material is produced. The mean grain size, denoted by d₅₀, is understood to mean the diameter in the case of which 50% by mass of the pulverulent starting material has a greater diameter and 50% ty mass of the pulverulent starting material has a smaller diameter, and can be for example between <1 μm and 10 μm. In the case of normally distributed, monomodal grain size distributions, the d₅₀ also represents the maximum of the distribution density curve.

That partial region of the third region which adjoins the first region and the first region can furthermore have coefficients of thermal expansion which differ by less than 2*10⁻⁶/K, and that partial region of the third region which adjoins the second region and the second region can have coefficients of thermal expansion which differ by less than 2*10⁻⁶/K. The coefficients of expansion of the partial regions among one another can similarly differ by less than 2*10⁻⁶/K. Therefore, by way of example, the coefficient of expansion of the first region can gradually draw near the coefficient of expansion of the second region via the coefficients of expansion of the partial regions of the third region. It is therefore possible to provide a molded body which comprises a first region and a second region that both have coefficients of expansion which differ by more than 2*10⁻⁶/K. The third region, which is shaped as the intermediary region, can represent a transition between the coefficients of expansion between the different coefficients of expansion of the first and second regions by virtue of the abovementioned selection of the coefficients of expansion in the third region.

Furthermore, the first ceramic material of the first region of the molded body may have a perovskite structure having the formula Ba_{1-x-y}MₓD_{y}Ti_{1-a-b}NₐMn_{b}O₃. In this case, x is selected from the range 0 to 0.5, y from the range 0 to 0.01, a from the range 0 to 0.01, and b from the range 0 to 0.01. M may comprise a divalent cation, D a trivalent or tetravalent donor and N a pentavalent or hexavalent cation. M may be, for example, calcium, strontium or lead, and D may be, for example, yttrium or lanthanum. Examples of N are niobium or antimony. The first ceramic material may comprise metallic impurities that are present with a content of less than 10 ppm. The content of metallic impurities is necessarily so small so as not to have a negative effect on the PTC properties of the first ceramic, electroceramic material.

The first ceramic material in the molded body may also have a Curie temperature which is selected from a range which comprises −30° C. to 340° C. Furthermore, the first ceramic material may have a resistivity at 25° C. which lies in a range from 3 Ω·cm to 100 000 Ωcm.

As a result of the use of a first ceramic material with a positive temperature coefficient of the electrical resistance, the molded body comprises a first region, which is heated by applying a voltage and can give off this heat to the surroundings. In this case, this first ceramic, electroactive material has an electrothermally self-regulating behavior. If the temperature in the first region reaches a critical value, the resistance in this region also increases, so that less current flows through the first region. This prevents further heating-up of the first region, so that no additional electronic control has to be provided.

The second ceramic material of the second region of the molded body may comprise an oxide ceramic. The oxide ceramic may be selected from a group which comprises ZrO₂, Al₂O₃ and MgO. The use of other and further oxide ceramics is possible as well. These oxide ceramics have high mechanical strength, for example with respect to abrasion, and a high chemical resistance, for example with respect to acids and bases. Furthermore, they are suitable for food contact applications and can therefore without any hesitation be brought into contact with materials, for example media no be heated, that must not be contaminated.

If the molded body is used for example in a heating device, the second region of the molded body may be formed in such a way that it adapts optimally to the respective geometry in terms of design.

It is therefore possible to provide a one-piece molded body which makes it possible to combine electrothermal functionality of the first ceramic material, an electroceramic, and mechanical and chemical stability of the second ceramic material, a structural ceramic. Both regions can be joined together in one molded body on account of the third region arranged therebetween and the coefficients of expansion which are selected for all regions in accordance with the abovementioned criteria.

Furthermore, the molded body can be produced by means of injection molding, and consequently can be shaped in any geometric form that is necessary for the respective structural surroundings. If the molded body is used in a heating device, the first region can therefore also be shaped in such a manner that it can be arranged in regions of the structure that are difficult to access. In this way, for example, a medium can be heated efficiently with very short heating-up times and low heating power outputs.

Furthermore, the third ceramic material can comprise a mixture of first ceramic material and second ceramic material in any desired ratio which is selected from a range of 95:5 to 5:95, advantageously from a range of 90:10 to 10:90.

If the third region comprises at least two partial regions, the partial regions can each comprise a mixture of first ceramic material and second ceramic material in any desired ratio which is selected from a range of 95:5 to 5:95, advantageously from a range of 90:10 to 10:90.

The mixture of first ceramic material and second ceramic material in the third region or in the partial regions of the third region can be selected in a targeted manner, such that the coefficients of expansion of the respectively adjacent regions or partial regions are adapted to one another in such a manner that they differ by less than 2*10⁻⁶/K.

The ratio between first ceramic material and second ceramic material can change gradually between two respective partial regions. This means, for example, that the partial region which adjoins the first region has the highest content of first ceramic material, and the partial region which adjoins the second region has the lowest content of first ceramic material, in which case—if several further partial regions are present between the partial regions which adjoin the first and second regions—the content of first ceramic material reduces gradually from partial region to partial region.

The third ceramic material can furthermore have additives which are different from the first ceramic material and the second ceramic material. By way of example, these additives can be mixed oxides of calcium oxide, strontium oxide, yttrium oxide and manganese oxide.

The third region can inhibit, or prevent the diffusion of constituents of the first ceramic material and of the second ceramic material. This inhibition can be improved further by the addition of additives. By way of example, barium-strontium titanate can be added to the third ceramic material in the case where doped BaTiO₃ is used as the first ceramic material, and ZrO₂ is used as the second ceramic material. The third ceramic material can also be doped in a targeted manner with Y₂O₃ and Mn₂O₃, example.

By way of example, constituents can be anions or cations which are present in the first ceramic material or in the second ceramic material. This avoids mutual impairment of the functional and/or structural properties of the first and second regions.

With said materials for the first, second and third ceramic materials, a material combination is selected chat has suitable phases between the first region and the third region and also between the second region and the third region and also, if appropriate, between the individual partial regions of the third region. “Phases” may comprise mixed crystals of the first and second ceramic materials. Such mixed crystals may be, or example, barium-lead-zirconium titanates if zirconium oxide is selected as the second ceramic material. In the case of Al₂O₃ or MgO as the second ceramic material, the mixed crystals may correspondingly be barium-aluminum titanate or barium-magnesium titanate. “Suitable” means in this context that the regions which adjoin one another have similar coefficients of expansion. The coefficients of expansion of the materials used in the first region, second region and third region may be adapted to one another in such a manner that no stress cracks form under heating.

Also provided is a heating device which comprises a molded body with the aforementioned properties. The heating device may comprise the molded body on which electrical contacting areas for producing a current flow in the molded body are arranged. In this case, the first region of the molded body may be provided with the electrical contacting areas. This produces the current flow in the first region of the molded body.

With a heating device which comprises a first, functional region and a second, structural region, the separation of medium to be heated and the electroceramic material can be realized. This allows the regions of the heating device that are subject to mechanical or else abrasive loads so be isolated from the electrical, function. The use of the second ceramic material in the second region also allows media that must not be contaminated to be heated. Dissolving of constituents of the first region by the medium to be heated is also prevented, by the second region being present between the first region and the medium to be heated.

Also provided is a method for producing a molded body. The method comprises the method steps of
A) providing a first ceramic starting material,
B) providing a second ceramic starting material,
C) providing at least one third ceramic starting material which comprises a mixture of first and second ceramic starting material,
D) producing a green body, which comprises a first region, comprising the first ceramic starting material, a second region, comprising the second ceramic starting material, and a third region, comprising the third ceramic starting material, and
E) sintering the green body to produce the molded body,

wherein, in method steps A), B) and C), the starting materials are selected in such a manner that the sintered ceramic materials have coefficients of thermal expansion, the coefficients of thermal expansion of the first and of the third ceramic material and of the second and of the third ceramic material differing by less than 2*10⁻⁶/K.

In method step E) of the method, the first ceramic starting material is transformed into a first ceramic material with a positive temperature coefficient of the electrical resistance.

With this method, a one—piece ceramic molded body which makes it possible to combine electrothermal functionality in the form of the first ceramic material and mechanical and chemical stability in the form of the second ceramic material can be provided in a shaping process. The joint production of these regions avoids having to produce a number of individual components and fasten them to one another with form-fitting engagement. The joint sintering of the first ceramic material, which is an electroceramic material, and of the second ceramic material, which is a structural ceramic material, forms at least two regions in a molded body that have the desired electrical and mechanical properties and are sintered to one another to form a one-piece molded body.

In method step A), a first ceramic starting material which has a structure having the formula Ba_{1-x-y}MₓD_{y}Ti_{1-a-b}NₐMn_{b}O₃ can be provided. In this case, x comprises the range 0 so 0.5, y the range 0 so 0.01, a she range 0 to 0.01, b the range 0 to 0.01, M a divalent cation, D a trivalent or tetravalent donor and N a pentavalent or hexavalent cation. This starting material can be transformed into a first ceramic material with a positive temperature coefficient of the electrical resistance, for example an electroceramic material, and has a perovskite structure.

In order to produce the first ceramic starting material, with less than 10 ppm of metallic impurities, it can be produced with molds which have a hard coating in order to avoid abrasion. A hard coating may, for example, consist of tungsten carbide. All the surfaces of the molds that come into contact with the first ceramic starting material may be coated with the hard coating.

In this way, a first ceramic starting material that can be transformed into a first ceramic PTC material, by sintering can be mixed with a matrix and processed to forms granules. These granules can be injection-molded for further processing.

The matrix in which the first ceramic starting material is incorporated and which has a lower melting point than the first ceramic starting material may in this case make up a proportion of less than 20% by mass with respect to the first ceramic starting material. The matrix may comprise a material selected from a group which comprises wax, resins, thermoplastics and water-soluble polymers. Further additives, such as antioxidants or plasticizers, may likewise be present.

Furthermore, in method step B), the second ceramic starting material can be mixed with a matrix and processed to form granules which can be injection-molded for further processing.

The matrix in which the second ceramic starting material is incorporated and which has a lower melting point than the second ceramic starting material may in this case make up a proportion of less than 20% by mass with respect to the second ceramic starting material. The matrix may comprise a material selected from a group which comprises wax, resins, thermoplastics and water-soluble polymers. Further additives, such as antioxidants or plasticizers, may likewise be present.

Furthermore, in method step C), the third ceramic starting material can be mixed with a matrix and processed to form granules which can be in for further processing.

The matrix in which the third ceramic starting material is incorporated and which has a lower melting point than the third ceramic starting material may in this case make up a proportion of less than 20% by mass with respect to the third ceramic starting material. The matrix may comprise a material selected from a group which comprises wax, resins, thermoplastics and water-soluble polymers. Further additives, such as antioxidants or plasticizers, may likewise be present.

In method step C), a mixture of first, ceramic starting material and second ceramic starting material is provided as the third ceramic starting material. Furthermore, additives, for example mixed oxides, which are different from the first and second starting materials can be added to the third ceramic starting material.

During the sintering in method step E), the first ceramic starting material is transformed into the first ceramic material of the molded body that has a positive temperature coefficient of the electrical, resistance, the second ceramic starting material is transformed into the second ceramic material of the molded body and the third ceramic starting material is transformed into the third ceramic material of the molded body, and the matrix is removed.

A material which can be transformed by sintering into an oxide ceramic selected from a group which comprises ZrO₂, Al₂O₃ and MgO may be selected as the second ceramic starting material. Further oxide ceramics are likewise possible.

When selecting the first ceramic starting material, the second ceramic starting material and the third ceramic starting material, a suitable match should be found between the shaping properties and the sintering conditions. For example, the materials should be sintered with the same maximum temperatures, holding times and cooling gradients. In order to realize joint sintering of the first ceramic starting material and of the second ceramic starting material in the same process, the sintering temperature can be increased in the case of the first ceramic starting material and lowered in the case of the second ceramic starting material by suitable measures. Suitable measures are, for example, adding oxides with calcium, strontium, lead or zirconium to the first ceramic starting material or adding oxides with elements from the group of alkalis, alkaline earths, titanium oxide or silicon oxide, for example oxides with yttrium, calcium or cerium, to the second ceramic starting material. This allows the physical parameters of the first ceramic starting material and of the second ceramic starting material to be modified in such a way that a common process window can be achieved for processing the two materials.

Furthermore, the match can be found by arranging at least one third ceramic starting material between the region of the first ceramic starting material and the region of the second ceramic starting material. In this case, the at least one third ceramic starting material can be applied to the first ceramic starting material, by means of screen printing, for example, and then the second ceramic starting material can be applied in turn to the third ceramic starting material by means of screen printing. If the third region of the molded body is to comprise a plurality of partial regions, a plurality of different third ceramic starting materials can be applied to the first ceramic starting material in succession by means of screen printing.

In method steps A), B) and C), for example, the first ceramic starting material, the second ceramic starting material and the third ceramic starting material can be selected such that they have coefficients of expansion which differ by less than 2*10⁻⁶/K between the first ceramic starting material and the third ceramic starting material and also between the second ceramic starting material and the third ceramic starting material.

In the joint sintering in method step E), the first, the second and the third regions are formed, having such coefficients of expansion that excessive mechanical stresses which lead to thermo-mechanically induced cracking cannot form between the regions. For this purpose, excessive amounts of low-melting eutectics should not be formed in the interfacial regions between the materials during the sintering. In this way, sufficient dimensional stability of the molded body is ensured.

In method step D), a shaping process selected from multi-component injection molding, multilayer extrusion and lamination of cast or drawn ceramic films may be used. By means of injection molding, for example, it is possible to provide molded bodies in any desired geometry, which can be adapted to the respective conditions and structural demands.

The invention will be explained in still more detail on the basis of the figures and exemplary embodiments.

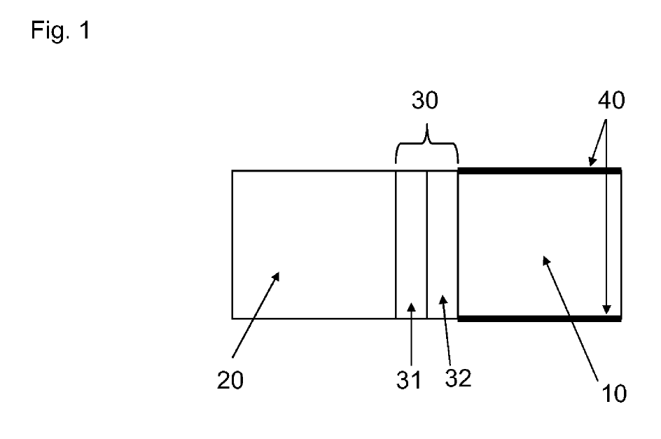

FIG. 1 shows the schematic side view of a first embodiment of a heating device,

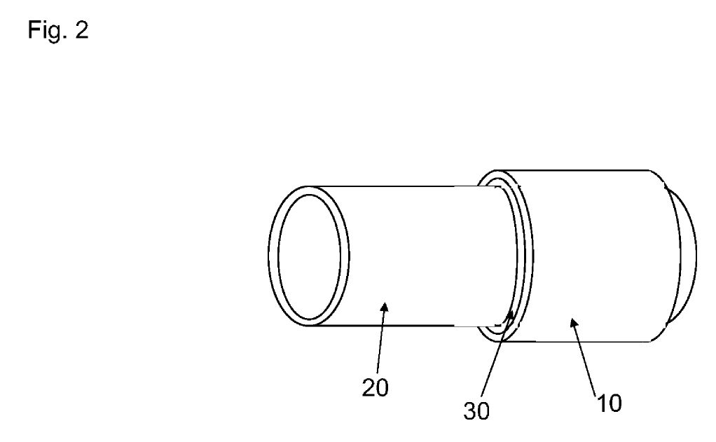

FIG. 2 shows the schematic perspective view of a second embodiment of a heating device.

FIG. 1 shows the schematic side view of a first embodiment of a heating device. This comprises a first region 10 and a second region 20 and a third region 30, which here is shown by way of example with two partial regions 31, 32. These three regions together form she molded body. Arranged on the first region 10 are two electrical contacting area 40, which can be contacted by way of electrical terminals. The first region 10, the second region 20 and the third region 30 are sintered to one another, so that additional fastening of the two regions to one another is not necessary and the molded body is formed as one piece.

The first reaction 10 comprises a first ceramic material of the structure Ba_{1-x-y}MₓD_{y}Ti_{1-a-b}NₐMn_{b}O₃, which furthermore may be doped with a rare earth, such as for example calcium, strontium, lead or zirconium. With this first ceramic material, which has a perovskite structure, the first region has a positive temperature coefficient of the electrical resistance.

The second region 20 may comprise a second ceramic material, for example an oxide ceramic, which likewise may be doped with elements from the group of alkalis, alkaline earths, titanium or silicon, for example yttrium, calcium or cerium.

The third region 30 contains a mixture of the first ceramic material and the second ceramic material, wherein the ratio between first ceramic material and second ceramic material is selected from a range which comprises 95:5 to 5:95, advantageously 90:10 to 10:90. The ratio can change from partial region to partial region of the third region. By way of example, the proportion of first ceramic material may be greater in the partial region 32 than in the partial reaction 31.

In this way, the mechanical and chemical load-bearing capabilities of the second ceramic material are combined with the electrical functionality of the first ceramic material in a one-piece molded body.

In the production of the molded body, a joint shaping process (CIM, Ceramic injection Molding) is used to bond together the first, second and third ceramic materials that have been made to match one another in their coefficients of thermal expansion. The coefficients of thermal expansion must in this case advantageously have differences of less than 2*10⁻⁶/K, which can be achieved by the appropriate dopings of the materials, over the entire temperature range from 1260° C., where there is a mixture of solid BaTiO₃ and liquid BaTiSiO₅, to room temperature, that is to say even below the liquid-phase sintering temperature. According to the composition, liquid phases of the first ceramic and second ceramic materials may occur at temperatures above 940° C.

In the critical temperature range with great stresses, the ceramic materials should be cooled slowly, for example by 0.2° C. per minute. The critical temperature range may in this case lie between room temperature and 1260° C.

In order to achieve sintering capabilities up to densities of 99% of the first ceramic material, grain sizes of less than 1 μm before the sintering process, or sintering aids, such as for example SiO₂, TiO₂ or FeO, may be used. In this way, sintering temperatures of less than 1400° C. are possible with sintering times of less than 120 minutes.

If the first ceramic materials comprise amounts of lead, very low sintering temperatures below 1300° C. can be used to prevent enrichment of the lead in the structural ceramic material.

Amounts of binder in the first ceramic and/or second ceramic and/or third ceramic material as well, as pressing or joining forces are sec to similar shrinkage values during the debinding and sintering, which leads to amounts of binder of over 1% by weight.

FIG. 2 shows the schematic perspective view of a further embodiment of the heating device. Here, the first region 10 and the second region 20 and the third region 30, which together form the molded body, are each formed as a pipe, the first region 10 surrounding the second region 20 and the third region 30 being arranged between the first and the second regions. On both end faces of the first region 10 there are electrical contacting areas (not shown here).

Through such a pipe there may be passed, for example, a medium that is heated when a voltage is applied through the first region, while the second region 20 provides the mechanical and chemical stability of the molded body during the flowing of the medium through the pipe. Contamination of the medium to be heated or destruction of the first region by the medium are inhibited, since the second region 20 is present between the medium to be heated and the first region 10.

The embodiments shown in the figures and exemplary embodiments can be varied as desired it should also be taken into consideration that the invention is not restricted to the examples but allows further refinements that are not specified here.

### LIST OF DESIGNATIONS

10 First region
20 Second region
30 Third region
31 Partial region
32 Partial region
40 Electrical contacting area

1. A molded body, comprising
a first region that has a first ceramic material with a positive temperature coefficient of electrical resistance,
a second region that has a second ceramic material, and
a third region that is arranged between the first region and the second region and that has a third ceramic material,
wherein the first region and the third region have coefficients of thermal expansion that differ by less than 2*10⁻⁶/K, and
wherein the second region and the third region have coefficients of thermal expansion that differ by less than 2*10⁻⁶/K.

2. The molded body according to claim 1, wherein the third region has at least two partial regions and the first region and the second region adjoin in each case one of the partial regions of the third region.

3. The molded body according to claim 2, wherein that partial region of the third region that adjoins the first region and the first region have coefficients of thermal expansion that differ by less than 2*10⁻⁶/K, and that partial region of the third region that adjoins the second region and the second region have coefficients of thermal expansion that differ by less than 2*10⁻⁶/K.

4. The molded body according to claim 1, wherein the first ceramic material has a perovskite structure with the formula
Ba1-x-yMxDyTi1-a-bNaMnbO3, where x=0 to 0.5, y=0 to 0.01, a=0 to 0.01, b=0 to 0.01, M comprises a divalent cation, D comprises a trivalent or tetravalent donor and N comprises a pentavalent or hexavalent cation.

5. The molded body according to claim 1, wherein the second ceramic material comprises an oxide ceramic that is selected from a group that comprises ZrO2, Al2O3 and MgO.

6. The molded body according to claim 1, wherein the third ceramic material comprises a mixture of first ceramic material and second ceramic material in a ratio that is selected from a range of 90:10 to 10:90.

7. The molded body according to claim 3, wherein the at least two partial regions of the third region each comprise a mixture of first ceramic material and second ceramic material in a ratio that is selected from a range of 90:10 to 10:90.

8. The molded body according to claim 7, wherein the ratio between first ceramic material and second ceramic material changes gradually between respectively adjacent partial regions.

9. The molded body according to claim 8, wherein the third ceramic material has additives which that are different from the first ceramic material and the second ceramic material.

10. The molded body according to claim 9, wherein the third region inhibits the diffusion of constituents of the first ceramic material and of the second ceramic material.

11. A heating device comprising a molded body, the molded body comprising:
a first region that has a first ceramic material with a positive temperature coefficient of the electrical resistance,
a second region that has a second ceramic material, and
a third region that is arranged between the first region and the second region and that has a third ceramic material,
wherein the first region and the third region have coefficients of thermal expansion that differ by less than 2*10⁻⁶/K, and
wherein the second region and the third region have coefficients of thermal expansion that differ by less than 2*10⁻⁶/K.

12. The heating device according to claim 11, wherein electrical contacting areas for producing a current flow in the molded body are arranged on the molded body.

13. The heating device according to claim 12, wherein the first region of the molded body is provided with the electrical contacting areas.

14. A method for producing a molded body with the method steps of
providing a first ceramic starting material,
providing a second ceramic starting material,
providing at least one third ceramic starting material that comprises a mixture of first and second ceramic starting material,
producing a green body that comprises a first region, comprising the first ceramic starting material, a second region, comprising the second ceramic starting material, and a third region, comprising the third ceramic starting material, and
sintering the green body to produce the molded body,
wherein, in the method steps of providing a first ceramic starting material, providing a second ceramic starting material, and providing at least one third ceramic starting material, starting materials are selected in such a manner that the sintered ceramic materials have coefficients of thermal expansion, the coefficients of thermal expansion of the first and of the third ceramic material and of the second and of the third ceramic material differing by less than 2*10⁻⁶/K.

15. The method according to claim 14, wherein, in method step D), a shaping process selected from multi-component injection molding, multilayer extrusion and lamination of cast or drawn films is used.
